(19) United States
(12) Patent Application Publication
(10) Pub. No.: US 2004/0127381 A1
(43) Pub. Date: Jul. 1, 2004

(54) Dual-compartment laundry composition containing equilbrium peracid solution

(75) Inventors: Stefano Scialla, Rome (IT); Connie Lynn Sheets, Cincinnati, OH (US)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/679,578

(22) Filed: Oct. 6, 2003

Related U.S. Application Data
(63) Continuation-in-part of application No. 09/980,328, filed on Nov. 30, 2001, now Pat. No. 6,699,828.

(51) Int. Cl. C11D 7/18

(52) U.S. Cl. 510/372

(57) ABSTRACT

Stable aqueous laundry product provided in a first and second part contained within a package and physically separated from each other, where the first part comprises a liquid cleaning composition having a pH of from about 4 to about 10 and contains a detersive surfactant system; and a second part comprises a bleaching composition and has a pH of from about 0.5 to about 6, and contains an equilibrium peracid solution. The equilibrium peracid solution comprises: a source of hydrogen peroxide; from about 20% to about 98% water; a water soluble carboxylic acid; and a corresponding percarboxylic acid. Methods of laundering fabrics in a washing machine utilizing such laundry products.

### CROSS-REFERENCE TO RELATED APPLICATIONS

This application is a continuation-in-part of prior U.S. application Ser. No. 09/980,328, filed Jun. 27, 2000, claiming benefit of U.S. Provisional application serial No. 60/141,340, filed Jun. 28, 1999.

### FIELD OF INVENTION

The present invention relates to two-part liquid laundry cleaning products wherein the products contain a cleaning part and a bleaching part and provide improved cleaning and whitening performance.

### BACKGROUND OF THE INVENTION

Many liquid cleaning compositions that may be used in the laundering process are currently commercially available to consumers. These cleaning compositions all provide benefits, some of the detergent cleaning compositions also propose to provide additional benefits, such as softnening of fabrics; brightening of colored clothing; and/or anti-microbial benefits. However, there are very few liquid laundry detergents currently commercially available that provide a bleaching composition. Incorporation of a bleaching composition into a liquid laundry detergent is often difficult due to the inherent instability associated with bleach in combination with enzymes or other common liquid laundry detergent ingredients that are sensitive to oxidation.

One solution for providing liquid laundry detergents with bleaching benefits is to use a dual-compartment container for separating the reactive ingredients until the time of delivery. Such separation allows for more formulation flexibility. However, with the multiple-compartment containers comes additional cost. In order to justify the cost in the sale of the final product, the compositions to be placed in the container also need to be optimized in order to find additional consumer-recognizable benefits. Therefore, notwithstanding prior art attempts to solve the bleach instability problem, there is a continuing need to identify improved cleaning compositions, bleaches, and combinations thereof that offer improved cleaning and are especially effective for laundering fabrics. There is further a need to identify cleaning compositions wherein the components do not have significant negative interactactions with one another during storage.

### SUMMARY OF THE INVENTION

It has now surprisingly been found that a combination of packaging and particular bleach ingredients may be utilized to provide improved cleaning. It has surprisingly been discovered that delivery of the combination of an acidic equilibrium peracid solution and a liquid laundry cleaning composition into the wash water provides benefits to which the prior art is unaware.

The present invention relates to stable aqueous laundry products provided in a first and second part comprising:

a) a first part liquid cleaning composition having a pH of from about 4 to about 10;

b) a second part bleaching composition having a pH of from about 0.5 to about 6,

wherein the bleaching composition includes an equilibrium peracid solution, and wherein the equilibrium peracid solution comprises:

i) hydrogen peroxide;

ii) from about 20% to about 98% water;

iii) a water soluble carboxylic acid;

iv) a corresponding percarboxylic acid;

wherein the first and second parts are contained within a package wherein the first part is physically separated from the second part.

These and other features, aspects, and advantages of the present invention will become evident to those skilled in the art from a reading of the present disclosure.

### DETAILED DESCRIPTION OF THE INVENTION

All documents cited are, in relevant part, incorporated herein by reference; the citation of any document is not to be construed as an admission that it is prior art with respect to the present invention.

While the specification concludes with the claims particularly pointing out and distinctly claiming the invention, it is believed that the present invention will be better understood from the following description.

All percentages and ratios used herein are by weight of the total composition and all measurements made are at 25° C., unless otherwise designated.

The compositions of the present invention can include, consist essentially of, or consist of, the components of the present invention as well as other ingredients described herein. As used herein, “consisting essentially of” means that the composition or component may include additional ingredients, but only if the additional ingredients do not materially alter the basic and novel characteristics of the claimed compositions or methods.

All percentages, parts and ratios are based upon the total weight of the liquid laundry products of the present invention, unless otherwise specified. All such weights as they pertain to listed ingredients are based on the active level and, therefore, do not include carriers or by-products that may be included in commercially available materials, unless otherwise specified.

It has now been found that the delivery of a liquid laundry product containing an acidic equilibrium peracid solution to the laundry wash water provides improved cleaning capability. In addition, without being limited by theory, it is believed that by physically separating two parts of such a liquid laundry product until the time (or near the time) of use, the product formulator is provided with an opportunity to provide cleaning and fabric care advantages not possible within a single-compartmentalized product. The combination of the liquid cleaning composition and the acidic equilibrium peracid solution with the two-part formulation flexibility provides cleaning benefits to which the present inventors were heretofore unaware.

The laundry products of the present invention are provided in a first and second part comprising: a) a first part comprising a liquid cleaning composition, said cleaning composition having a pH of from about 4 to about 10; b) a second part comprising a bleaching composition having a pH of from about 0.5 to about 6, wherein the bleaching composition comprises an equilibrium peracid solution, and wherein the equilibrium peracid solution comprises: hydrogen peroxide; from about 20% to about 98% water; a water soluble carboxylic acid; and a corresponding percarboxylic acid; wherein the first and second parts are contained within a package wherein the first part is physically separated from the second part.

The liquid laundry products, liquid cleaning compositions, and bleaching compositions herein may also include a wide variety of other ingredients. The liquid laundry products of the present invention, are described in detail hereinafter.

Laundry Product

As used herein, “liquid laundry products” include hand and machine laundry detergent compositions including laundry additive compositions and compositions suitable for use in the soaking and/or pretreatment of stained fabrics.

The liquid laundry products of the present invention are provided in two parts. The two parts are contained within a package and are physically separated. Examples of physical separation include dual compartment containers, such as dual-compartment bottles like that described in U.S. Pat. No. 4,678,103 to Dirksing. In such bottles, one part of the composition is in one compartment and the other part of the composition is in the other compartment. The two parts preferably do not mix until cleaning performance is desired, such as when the aqueous liquid composition is being poured into a dosing device and/or washing machine.

Preferred packages for use herein are dual-compartment containers. Examples of dual-compartment containers useful herein include the commercially available container used for the “Dobbelman Duo,”™ liquid laundry detergent product distributed in Holland by Sara Lee™ that is the subject of Netherlands Patent No. NL 1018746C to Sara Lee published Sep. 16, 2002. This “Dobbelman Duo”™ two part laundry product is contained within a container formed from two separate plastic containers glued together and the compositions are dispensed by top-pouring from two separate openings. Other examples of preferred dual-compartment containers are those found in U.S. Patent Application Publication No. U.S. 2002/0030063 A1 to Procter and Gamble, published Mar. 14, 2002. However it is also envisaged that the container may comprise more than two compartments, with the caveat that this may add to the overall container cost.

The packages of the present invention may be substantially rigid, flexible or collapsible and may be made from plastic, glass, metal or metal alloy or combinations thereof. Preferably the container, including all elements of the container, is made from plastic, more preferably thermoplastic material. Examples of preferred thermoplastic materials include polypropylene (PP), polyethylene (PE), polyethylene terephthalate (PET) or combinations thereof.

Packages of the present invention are intended for containing multiple, variable, doses of the same compositions. Therefore, so-called “unit-dose” packages which are known for providing a single dose of liquid laundry detergent are typically not preferred as packages according to the present invention, even if they are constructed with more than one compartment.

Preferably, the package of the present invention is selected from the group consisting of dual-compartment bottles, dual-compartment bags, dual compartment boxes, and combinations thereof. More preferably, the package of the present invention is a dual-compartment bottle.

The packages of the present invention may have a means for dispensing. As used herein, “means for dispensing” may include simple orifices; more complex pouring orifices (such as those shaped or constructed to provide a steady flow rate); dispensers; pumps, tubes, or combinations thereof.

Preferably the means for dispensing includes a dispenser. As used herein, “dispenser” refers to any system of withdrawing, removing, or channeling the liquid formulations of the present invention from the container either directly to a washing basin/machine drum or to a measuring cup or other means of introducing the compositions into the laundry process. Preferred dispensers herein include those that are gravity fed. Preferred gravity-fed dispensers include press-tap dispensers, i.e., those that are triggered by the press of a button or tab.

Preferably the compartments of the container are designed such that the user can dispense a constant ratio of product from the first compartment and the second compartment throughout use. Methodology for calculating flow ratios, volume dispensed, container manufacture parameters, etc. may be found in U.S. Patent Application Publication No. U.S. 2002/0030063 A1.

Preferably, the laundry products according to the present invention are characterized by a delivered (once dispensed) ratio between the first part (cleaning composition) and the second part (bleaching composition) that ranges from about 10:90 to about 90:10, preferably from about 20:80 to about 80:20, more preferably from about 30:70 to about 70:30, even more preferably from about 40:60 to about 60:40. Therefore, the dispensing means is preferably, capable of dispensing such a first part (cleaning composition) to second part (bleaching composition) ratio. The dispensing means may even be a pour-top container with a dispensing ratio of about 50:50. It will be understood by one of ordinary skill that it is possible to formulate each partial composition to interact with the dispensing ratio in order to deliver a particular combination of ingredients to the dispensed formulation.

Cleaning Composition

The liquid laundry products of the present invention include a first part containing a liquid cleaning composition which is preferably a liquid detergent cleaning composition.

The cleaning compositions according to the present invention have a pH of from about 4 to about 10, preferably from about 6 to about 9.

“Liquid cleaning compositions” as used herein include heavy duty liquid laundry detergent compositions, light duty liquid laundry detergent compositions, liquid fabric softeners, liquid fabric conditioners, laundry pretreaters, products for pre-soaking laundry, laundry additives and combinations thereof. Preferably, the liquid detergent compositions herein are heavy duty aqueous liquid laundry detergent compositions.

Preferably, the liquid cleaning compositions of the present invention useful herein comprise:

(a) at least one element selected from surfactants (see examples hereinafter); and

(b) optionally, but preferably, one or more cleaning adjunct materials.

The liquid cleaning compositions useful herein preferably comprise from about 3% to about 98%, preferably from about 15% to about 95%, by weight of the liquid cleaning composition, of an aqueous liquid carrier which is preferably water. Preferably, the cleaning compositions according to the present invention should provide a wash solution pH from about 6 to about 10, more preferably from about 7 to about 9, in order to maintain a preferred stain removal performance by the liquid laundry products according to the present invention. If needed, the cleaning compositions may contain alkalinizing agents, pH control agents and/or buffering agents.

The density of the liquid cleaning compositions herein preferably ranges from about 400 to about 1200 g/litre, more preferably from about 500 to about 1100 g/litre of composition measured at 20° C.

Surfactants

The liquid cleaning compositions of the present invention preferably comprise a detersive surfactant system which is a single surfactant or a mixture of two or more surfactants and/or co-surfactants. Preferably one or more surfactants are included in the cleaning composition, but it is possible to alternatively or additionally include surfactants in the bleaching composition. The surfactants useful herein include anionic surfactants, nonionic surfactants, amine oxide surfactants, ampholytic surfactants, polyhydroxy fatty acid amide surfactants, cationic surfactants, zwitterionic surfactants, diamine surfactants, and mixtures thereof. Surfactants useful herein include examples of which are given in “Surface Active Agents and Detergents” (Vol. I and II by Schwartz, Perry and Berch). Surfactants useful herein include those discussed more fully in PCT Published Application No. WO 01/00765, published Jan. 4, 2001. A variety of such surfactants are also generally disclosed in U.S. Pat. No. 3,929,678, issued Dec. 30, 1975 to Laughlin, et al and in U.S. Pat. No. 4,285,841, Barrat et al, issued Aug. 25, 1981. Preferably, the surfactant system contains a combination of one or more anionic surfactants and one or more nonionic surfactants.

The liquid cleaning compositions herein preferably comprises at least 0.2% surfactant, more preferably from about 5% to about 70%, more preferably from about 15% to about 30%, by weight of the cleaning composition, of the surfactant system. Any types and classes of surfactants, which are well-known in the art may be used herein. A description of preferred anionic and nonionic surfactants is provided below.

i. Anionic Surfactant

Anionic surfactants are preferred for use herein. Preferred anionic surfactants include C₁₁-C₁₈ alkyl benzene sulfonates (LAS) and primary, branched-chain and random C₁₀-C₂₀ alkyl sulfates (AS), the C₁₀-C₁₈ secondary (2,3) alkyl sulfates of the formula CH₃(CH₂)ₓ(CHOSO₃⁻M⁺)CH₃ and CH₃(CH₂)_{y}(CHOSO₃⁻M⁺)CH₂CH₃ where x and (y+1) are integers of at least about 7, preferably at least about 9, and M is a water-solubilizing cation, especially sodium, unsaturated sulfates such as oleyl sulfate, the C₁₀-C₁₈ alkyl alkoxy sulfates (“AEₓS”; especially EO 1-7 ethoxy sulfates), C₁₀-C₁₈ alkyl alkoxy carboxylates (especially the EO 1-5 ethoxycarboxylates), the C₁₀₋₁₈ glycerol ethers, the C₁₀-C₁₈ alkyl polyglycosides and their corresponding sulfated polyglycosides, and C₁₂-C₁₈ alpha-sulfonated fatty acid esters.

Particularly preferred anionic surfactants herein are the alkyl sulfates. Under cold water washing conditions, i.e., less than about 18.3° C., it is preferred that there be a mixture of ethoxylated and non-ethoxylated alkyl sulfates.

ii. Nonionic Surfactant

The surfactants useful herein include nonionic detergent surfactants. Useful nonionic surfactants include: C₈-C₁₈ alkyl ethoxylates (“AE”), with EO about 1-22, including the so-called narrow peaked alkyl ethoxylates and C₆-C₁₂ alkyl phenol alkoxylates (especially ethoxylates and mixed ethoxy/propoxy), alkyl dialkyl amine oxide, alkanoyl glucose amide, and mixtures thereof.

Preferred are the ethoxylated alcohols and ethoxylated alkyl phenols. Particularly preferred are ethoxylated alcohols having an average of from about 10 to about 15 carbon atoms in the alcohol and an average degree of ethoxylation of from about 6 to about 12 moles of ethylene oxide per mole of alcohol.

Other nonionic surfactants for use herein include, but are not limited to: the polyethylene, polypropylene, and polybutylene oxide condensates of alkyl phenols; alkyl ethoxylates; the condensation products of ethylene oxide with a hydrophobic base formed by the condensation of propylene oxide with propylene glycol; the condensation products of ethylene oxide with the product resulting from the reaction of propylene oxide and ethylenediamine; semi-polar nonionic detergent surfactants; and alkylpolysaccharide surfactants. A preferred alkyleneoxide for use herein is ethylene oxide. Preferred alkylpolyglycosides for use herein include fatty acid amide surfactants.

Cleaning Adjunct Materials

The liquid laundry products of the present invention preferably comprise at least one cleaning adjunct material. The liquid laundry products may include from about 1% to about 99.9% by weight of the composition of one or more cleaning adjunct materials. The term “cleaning adjunct materials”, as used herein, includes any liquid, solid or gaseous material able to contribute to any aspect of the performance and/or aesthetics of the liquid laundry products according to the invention, preferably compatible with the other ingredients present in the compositions of the present invention. Suitable cleaning adjunct materials are more fully discussed in PCT Published Application No. WO 01/00765, published Jan. 4, 2001.

The specific selection of cleaning adjunct materials are readily made by considering the surface, item or fabric to be cleaned. Examples of suitable cleaning adjunct materials include, builders, bleaching agents, bleach catalysts, enzymes, enzyme stabilizing systems, chelants, optical brighteners, soil release polymers, dye transfer agents, dispersants, suds suppressors, dyes, perfumes, colorants, filler salts, hydrotropes, photoactivators, fluorescers, fabric conditioners, fabric softening agents, hydrolyzable surfactants, preservatives, anti-oxidants, anti-shrinkage agents, anti-wrinkle agents, germicides, fungicides, color speckles, silvercare, anti-tarnish and/or anti-corrosion agents, alkalinity sources, solubilizing agents, carriers, processing aids, pigments, pH-jump systems (e.g. borate.polyol), pH control and pH buffering agents. Non-limiting examples of materials belonging to some of these classes are listed below.

i) Suspending Agents

The liquid laundry products of the present invention may preferably comprise, preferably as components of the bleaching composition, a suspending agent. As used herein, a “suspending agent” is an ingredient that is specifically added to the composition of the present invention to suspend a solid or partially-solid particulate ingredient of the composition.

Examples of suspending agents include gum-type polymers (e.g. xanthan gum), polyvinyl alcohol and derivatives thereof, cellulose and derivatives thereof and polycarboxylate polymers including, but not limited to: tamarind gum (preferably consisting of xyloglucan polymers), guar gum, locust bean gum (preferably consisting of galactomannan polymers), and other industrial gums and polymers, which include, but are not limited to, xanthan, gellan, welan, rhamsan, dextran, curdlan, hydroxyalkyl cellulose, galactan (preferably from lupin and potatoes), pectic galactan (preferably from potatoes), galactomannan (preferably from carob, and including both low and high viscosities), glucomannan, lichenan (preferably from icelandic moss), mannan (preferably from ivory nuts), acacia gum, agar, alginates, carrageenan, chitosan, clavan, hyaluronic acid, cellodextrins, carboxymethylcellulose (CMC), dextrans, dextrins, ethylhydroxyethylcellulose (EHEC), guar, hydroxyethylcellulose (HEC), hydroxypropylcellulose (HPC), hydroxybutylcellulose (HBC), methylcellulose (MC), tamarind, xanthan, carboxymethylhydroxyethylcellulose (CMHEC), methoxypropyl methyl cellulose (MPMC), hexylcarboxymethyl cellulose, C₁₂-C₂₀ alkyl carboxymethylcellulose, methylhydroxyethylcellulose (MHEC), methylhydroxypropylcellulose (MHPC), hydroxyethylmethylcellulose (HEMC), hydroxypropylmethylcellulose (HPMC), hydroxybutylmethylcellulose (HBMC) and mixtures thereof.

In a particularly preferred embodiment of the present invention, the suspending agent is selected from a gum-type polymer, preferably a xanthan gum, or a polycarboxylate polymer, preferably a homo or copolymer of monomer units selected from acrylic acid, methacrylic acid, maleic acid, malic acid, maleic anhydride, preferably in a MW range from 1,000,000 to 10,000,000.

The gum-type polymer, when present, is preferably present at a level of from 0.01% to 10%, most preferably from 0.1% to 3%.

The cross-linked polycarboxylate polymer, when present, is preferably present at a level of from 0.01% to 2% more preferably from 0.01% to 1%, most preferably from 0.1% to 0.8%.

In an alternative embodiment the suspending agent comprises a combination of at least two polymers. In this embodiment the first polymer is a gum-type polymer and the second is a cross-linked polycarboxylate polymer. The composition may additionally comprise further polymers.

The ratio of gum-type polymer to cross-linked polycarboxylate polymer is from 100:1 to 1:100, most preferably from 1:10 to 10:1.

ii) Bleach Activators

Various bleach activators may be present in the liquid laundry products according to the present invention. Examples include nonanoyl oxy benzene sulphonate (NOBS), alkanoyl oxy benzene sulphonate (AOBS), where the alkanoyl moiety can have a number of carbon atoms ranging from 4 to 15, tetraacetyl ethylene diamine (TAED), benzoylcaprolactam (BzCL), 4-nitrobenzoylcaprolactam, 3-chlorobenzoylcaprolactam, benzoyloxybenzenesulphonate (BOBS), phenyl benzoate (PhBz), benzoylvalerolactam (BZVL), carboxylic acid esters with alcohols, glycols, glycerol (e.g. triacetin, diacetin, tripropyrrin, dipropyrrin, tributyrrin, trihexanoin, trinonanoin), perhydrolyzable esters and mixtures thereof.

iii) Organic Peroxides, Especially Diacyl Peroxides

Organic peroxides are extensively illustrated in Kirk Othmer, Encyclopedia of Chemical Technology, Vol. 17, John Wiley and Sons, 1982 at pages 27-90 and especially at pages 63-72. If a diacyl peroxide is used, it will preferably be one which exerts minimal adverse impact on spotting/filming.

iv) Metal-Containing Bleach Catalysts

The liquid laundry products herein may include a metal-containing bleach catalyst that is effective for use in bleaching compositions. Suitable examples of metal-containing bleach catalysts are compounds based on Mn, Co, Fe, Ti, W, Mo, Cu, etc., which exert catalytic activity towards peracids, hydrogen peroxide or other organic or inorganic peroxides (and mixtures thereof).

v) Enzymes

The liquid laundry products of the present invention may further comprise one or more enzymes that provide cleaning performance benefits. Said enzymes include enzymes selected from cellulases, hemicellulases, peroxidases, proteases, gluco-amylases, amylases, lipases, cutinases, pectinases, xylanases, reductases, oxidases, phenoloxidases, lipoxygenases, ligninases, pullulanases, tannases, pentosanases, malanases, β-glucanases, arabinosidases, mannanases, xyloglucanases or mixtures thereof. A preferred combination is a cleaning composition having a cocktail of conventional applicable enzymes like protease, amylase, lipase, cutinase, mannanases, xyloglucanases and/or cellulase. Enzymes when present in the liquid cleaning compositions, are included at from about 0.0001% to about 5% of active enzyme by weight of the cleaning composition. The enzyme system, when present, is preferably formulated in the liquid cleaning composition, so as to avoid interaction with the peracid contained in the bleaching composition.

vi) Enzyme Stabilizers

Enzymes for use in cleaning compositions can be stabilized by various techniques. Enzyme stabilization techniques are disclosed and exemplified in U.S. Pat. No. 3,600,319, EP 199,405 and EP 200,586. Enzyme stabilization systems are also described, for example, in U.S. 3,519,570. A useful Bacillus, sp. AC13 giving proteases, xylanases and cellulases, is described in WO 9401532. The enzymes employed herein can be stabilized by the presence of water-soluble sources of calcium and/or magnesium ions in the finished compositions which provide such ions to the enzymes. Suitable enzyme stabilizers and levels of use are described in U.S. Pat. Nos. 5,705,464, 5,710,115 and 5,576,282.

vii) Chelating Agents

The liquid laundry products of the present invention herein may also optionally contain a chelating agent which serves to chelate metal ions and metal impurities which would otherwise tend to deactivate the bleaching agent(s). Preferably, the chelating agents are comprised at least in the bleaching compositions of the liquid laundry products according to the present invention. Useful chelating agents can include any of those known to those skilled in the art such as amino carboxylates, phosphonates, amino phosphonates, polyfunctionally-substituted aromatic chelating agents and mixtures thereof. Further examples of suitable chelating agents and levels of use are described in U.S. Pat. Nos. 5,705,464, 5,710,115, 5,728,671 and 5,576,282.

The presence of chelating agents contributes to further enhance the chemical stability of the compositions. Preferred phosphonate chelating agents to be used herein are diethylene triamine penta methylene phosphonate (DTPMP) and ethane 1-hydroxy diphosphonate (HEDP). Such phosphonate chelating agents are commercially available from Monsanto under the trade name DEQUEST®.

A preferred biodegradable chelating agent for use herein is ethylene diamine N,N′-disuccinic acid, or alkali metal, or alkaline earth, ammonium or substitutes ammonium salts thereof or mixtures thereof. Ethylenediamine N,N′-disuccinic acids, especially the (S,S) isomer have been extensively described in U.S. Pat. No. 4,704,233, Nov. 3, 1987, to Hartman and Perkins. Ethylenediamine N,N′-disuccinic acids is, for instance, commercially available under the tradename ssEDDS® from Palmer Research Laboratories.

Suitable amino carboxylates to be used herein include ethylene diamine tetra acetates, diethylene triamine pentaacetates, diethylene triamine pentaacetate (DTPA),N-hydroxyethylethylenediamine triacetates, nitrilotri-acetates, ethylenediamine tetrapropionates, triethylenetetraaminehexa-acetates, ethanol-diglycines, propylene diamine tetracetic acid (PDTA) (available from BASF as Trilon FS®) and methyl glycine di-acetic acid (MGDA), both in their acid form, or in their alkali metal, ammonium, and substituted ammonium salt forms.

Further carboxylate chelating agents useful herein include salicylic acid, aspartic acid, glutamic acid, glycine, malonic acid or mixtures thereof.

Typically, the compositions according to the present invention comprise up to about 15%, more preferably up to about 5% by weight of the total composition of a chelating agent, or mixtures thereof, preferably from 0.01% to 1.5% by weight and more preferably from 0.01% to 0.5%.

viii) Radical Scavengers

The liquid laundry products of the present invention may also comprise a radical scavenger or a mixture thereof.

Suitable radical scavengers for use herein include the well-known substituted mono and dihydroxy benzenes and their analogs, alkyl and aryl carboxylates and mixtures thereof. Preferred such radical scavengers for use herein include di-tert-butyl hydroxy toluene (BHT), hydroquinone, di-tert-butyl hydroquinone, mono-tert-butyl hydroquinone, tert-butyl-hydroxy anysole, benzoic acid, toluic acid, catechol, t-butyl catechol, benzylamine, 1,1,3-tris(2-methyl-4-hydroxy-5-t-butylphenyl) butane, n-propyl-gallate or mixtures thereof and highly preferred is di-tert-butyl hydroxy toluene. Such radical scavengers like N-propyl-gallate may be commercially available from Nipa Laboratories under the trade name Nipanox S1®.

Radical scavengers when used, are typically present herein in amounts up to about 10% by weight of the liquid laundry composition and preferably from about 0.001% to about 0.5% by weight of the liquid laundry composition. They are preferably comprised in the bleaching composition.

ix) Alkoxylated Benzoic Acid

The liquid laundry products according to the present invention may optionally, but preferably comprise an alkoxylated benzoic acid or a salt thereof. Preferably, said alkoxylated benzoic acid or the salt thereof is selected from the group consisting of 3,4,5,-trimethoxy benzoic acid, a salt thereof, 2,3,4-trimethoxy benzoic acid, a salt thereof, 2,4,5-trimethoxy benzoic acid, a salt thereof and a mixture thereof. More preferably, said alkoxylated benzoic acid or the salt thereof is 3,4,5,-trimethoxy benzoic acid or a salt thereof. The alkoxylated benzoic acid component should preferably be comprised in the bleaching composition.

x) Polymeric Stabilization System

The compositions of the present invention may optionally, but preferably comprise a polymeric stabilization system comprising polymeric compounds. “Polymeric compounds” as used herein includes oligomeric compounds and means polymeric and/or oligomeric compounds that are characterized by having both hydrophilic components and hydrophobic components. A detailed exemplification of polymeric compounds suitable for use in the compositions according to the present invention is provided in WO 01/00765 to Procter & Gamble. Preferably, the polymeric stabilization system is comprised at least in the bleaching composition, to improve the storage stability of the equilibrium peracid. More preferably, the polymeric compounds for use in the compositions of the present invention are selected from the group of polymeric compounds described in U.S. Pat. Nos. 4,702,857 to Gosselink, 4,968,451 to Scheibel et al., 5,415,807 to Gosselink et al. and mixtures thereof. When present, the compositions of the present invention will generally comprise from about 0.01% to about 10%, by weight of the composition, of the polymeric compounds, typically from about 0.1% to about 5%, preferably from about 0.02% to about 3.0%.

The compositions according to the present invention can be in a “concentrated form”, in such case, the compositions according to the present invention will contain a lower amount of water, compared to conventional compositions. Typically the water content of such a concentrated composition is preferably less than 40%, more preferably less than 30%, most preferably less than 20% by weight of the composition.

Further, the compositions according to the present invention may be isotropic liquids, aqueous gels and/or colored liquid compositions.

Bleaching Composition

The laundry products of the present invention include, as a second part, a bleaching composition. As used herein, “bleaching composition” refers generally to those compositions that may be used during the laundering process to remove or decolorize colored stains or dinginess from clothing/fabric items in the wash. In order to ensure the storage stability of the product, the pH of the bleaching composition should be in the range between 0 and 7, preferably 0.5 to 6, most preferably 1 to 5.

The bleaching compositions of the present invention contain an acidic equilibrium peracid solution. Preferably, the bleaching compositions of the present invention contain form about 0.1% to about 100%, by weight of the bleaching composition, of the equilibrium peracid solution, preferably from about 1% to about 90%, more preferably from about 10% to about 90%. As used herein, “equilibrium peracid solution” refers to those solutions in which an essentially aqueous solution comprises hydrogen peroxide; a water-soluble mono- or di- or polycarboxylic acid; and the corresponding percarboxylic acid(s). These components are present in concentrations determined by the well-known chemical equilibrium:

RCOOH+H2O2←→RCO3H+H2O

in a pH range usually varying between about 0.5 and about 6, preferably between about 0.5 and about 3. The equilibrium peracid solution comprises from about 20% to about 98%, by weight of the solution, of water, preferably from about 40% to about 90% water. As used herein “corresponding peroxyacid” or “corresponding percarboxylic acid” refers to the RCO3H compound in the above equation that is formed in the reaction and thus “corresponds” to the RCOOH compound. Note that the R moiety in both compounds is identical.

The carboxylic acid in equilibrium with the percarboxylic acid is present at a weight ratio of carboxylic acid to percarboxylic acid of preferably from about 100:1 to about 0.5:1, more preferably from about 50:1 to about 1:1, even more preferably from about 10:1 to 1:1. Commercial products contain for instance about 5% peracetic acid in equilibrium with about 28% hydrogen peroxide and about 8% acetic acid. Acids most commonly used are short chain, water soluble carboxylic acids, typically acetic or propionic acids. The alkyl part of the chain may be optionally substituted with one-or more substituents selected from halo-, nitro-, amido-, hydroxy-, carboxy-, sulpho-, or phosphono-groups. Contemplated from this group are monochloroperacetic acid, dichloroperacetic acid, trichloroperacetic acid, and trifluoroperacetic acid. Further examples include the monoperacids of dibasic carboxylic acids such as monopersuccinic acid, monoperglutaric acid, monoperadipic acid, and also percitric acid and pertartaric acid. Additionally the substituent may be further derivatised to give groups such as esters or ethers. Indeed, for lower odor impact formulations, short chain dicarboxylic acids such as glutaric, succinic or adipic and their monomethyl esters, and their mixtures thereof, can be used.

Examples of commercial products based on peracetic acid include Proxitane™ and Oxymaster™ both available from Solvay Interox. An example of commercial product based on monomethyl monoperoxyglutaric acid is Perestane™ available from Solvay Interox.

The bleaching compositions of the present invention also preferably comprise an adjunct material selected from the groups of polymeric stabilization systems, chelating agents, radical scavengers, and alkoxylated benzoic acids, to help the physical and chemical stabilization of the peroxyacid(s). All of these ingredients have been described in the corresponding paragraphs hereinbefore.

a) Hydrogen Peroxide Source

The equilibrium peracid solutions according to the present invention contain hydrogen peroxide and/or its sources thereof. The source of peroxide is preferably hydrogen peroxide, but may be any suitable source of peroxide and present at any level, such as fully described in U.S. Pat. No. 5,576,282. Preferably, the bleaching compositions comprise from about 0.001% to about 15%, by weight of the bleaching composition, of the peroxide and/or source of peroxide, more preferably from about 0.01% to about 10%, most preferably from about 0.1% to about 6%.

Examples of hydrogen peroxide sources useful herein include perborate compounds, percarbonate compounds, perphosphate compounds, urea-peroxide compounds, and mixtures thereof. Preferred peroxide sources useful herein include sodium perborate (any hydrate but preferably the mono- or tetra-hydrate), sodium carbonate peroxyhydrate or equivalent percarbonate salts, sodium pyrophosphate peroxyhydrate, urea peroxyhydrate, and/or sodium peroxide. Also useful are sources of available oxygen such as persulfate bleach (e.g., OXONE, ™ manufactured by DuPont™). Mixtures of any convenient hydrogen peroxide sources can also be used.

Various forms of sodium perborate and sodium percarbonate, such as coated and modified forms may be used.

Hydrogen peroxide and sources thereof may be used, in some embodiments of the present invention, also in the cleaning composition, provided that enzymes and other incompatible ingredients are not present.

b) Carboxylic Acids

The equilibrium peracid solutions of the present invention contain a water-soluble carboxylic acid. As used herein, “carboxylic acid” refers to monocarboxylic, dicarboxylic, and polycarboxylic acids, as well as mixtures thereof. Dicarboxylic acids are preferred. Non-limiting examples of carboxylic acids useful herein include, acetic acid, propionic acid, succinic acid, malic acid, glutaric acid, adipic acid, maleic acid, lactic acid, citric acid and mixtures thereof. Preferred for use herein are carboxylic acids selected from succinic, glutaric, malic, maleic, adipic, their monoalkyl esters and especially their monomethyl esters, and mixtures thereof.

c) Corresponding Percarboxylic Acid(s)

As used herein, “corresponding percarboxylic acid” refers to the respective percarboxylic acids derived from the carboxylic acids described hereinabove through the following equilibrium reaction with hydrogen peroxide:

RCOOH+H2O2←→RCO3H+H2O

In the case of di- or polycarboxylic acids, it is intended that the formation of mono-, or di-, or polycarboxylic acids will be possible (with one, two, or more percarboxylic groups), as determined by the relative concentrations of hydrogen peroxide and the parent carboxylic acid(s).

Preferably, the equilibrium peracid solution comprises from about 0.01% to about 50%, more preferably from about 0.05% to about 30%, by weight of the equilibrium peracid solution, of the percarboxylic acid.

d) Optional Suspended Peracid

Optionally, the equilibrium peracid solution may be used in combination with a suspended, more hydrophobic peracid, such as a suspension of a preformed Peroxy Carboxylic acid (hereinafter referred to as a “peroxyacid”). Any suitable peroxyacid compound known in the art may be used herein. The peroxyacid is preferably present in the bleaching composition at a level of from about 0.1% to about 25%, more preferably from about 0.1% to about 20%, even more preferably from about 1% to about 10%, by weight of the bleaching composition. Alternatively, the peroxyacid may be present at a much higher level of for example 10% to 40%, more preferably from 15% to 30%, most preferably from 15% to 25%, by weight of the bleaching composition.

Preferably, the peroxyacid is selected from the group consisting of percarboxylic acids and salts, percarbonic acids and salts, perimidic acids and salts, peroxymonosulfuric acids and salts, and mixtures thereof.

One class of suitable organic peroxycarboxylic acids have the general formula:

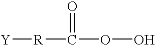

wherein R is an alkylene or substituted alkylene group containing from 1 to about 22 carbon atoms or a phenylene or substituted phenylene group, and Y is hydrogen, halogen, alkyl, aryl, —C(O)OH or —C(O)OOH.

Organic peroxyacids suitable for use in the present invention can contain either one or two peroxy groups and can be either aliphatic or aromatic. When the organic peroxycarboxylic acid is aliphatic, the unsubstituted acid has the general formula:

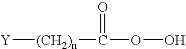

where Y can be, for example, H, CH₃, CH₂Cl, C(O)OH, or C(O)OOH; and n is an integer from 1 to 20. When the organic peroxycarboxylic acid is aromatic, the unsubstituted acid has the general formula:

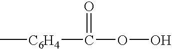

wherein Y can be, for example, hydrogen, alkyl, alkylhalogen, halogen, C(O)OH or C(O)OOH.

Monoperoxy acids useful herein include alkyl and aryl peroxyacids such as: peroxybenzoic acids and ring-substituted peroxybenzoic acids including peroxy-a-naphthoic acid, monoperoxyphthalic acid (magnesium salt hexahydrate), and o-carboxybenzamidoperoxyhexanoic acid (sodium salt); aliphatic, substituted aliphatic and arylalkyl monoperoxy acids, including peroxylauric acid, peroxystearic acid, N-nonanoylaminoperoxycaproic acid (NAPCA), N,N-(3-octylsuccinoyl)aminoperoxycaproic acid (SAPA) and N,N-phthaloylaminoperoxycaproic acid (PAP); and amidoperoxyacids including monononylamide of either peroxysuccinic acid (NAPSA) or of peroxyadipic acid (NAPAA).

Diperoxyacids useful herein include alkyl diperoxyacids and aryldiperoxyacids, such as: 1,12-diperoxydodecanedioic acid; 1,9-diperoxyazelaic acid; diperoxybrassylic acid; diperoxysebacic acid and diperoxyisophthalic acid; 2-decyldiperoxybutane-1,4-dioic acid; and 4,4′-sulfonylbisperoxybenzoic acid. Such bleaching agents are disclosed in U.S. Pat. No. 4,483,781, Hartman, issued Nov. 20, 1984; U.S. Pat. No. 4,634,551 to Burns et al.; European Patent Application 0,133,354 to Banks et al. published Feb. 20, 1985; and U.S. Pat. No. 4,412,934 to Chung et al. issued Nov. 1, 1983. Sources also include 6-nonylamino-6-oxoperoxycaproic acid as described in U.S. Pat. No. 4,634,551, issued Jan. 6, 1987 to Burns et al. Persulfate compounds such as for example OXONE, manufactured commercially by E.I. DuPont de Nemours of Wilmington, Del. can also be employed as a suitable source of peroxymonosulfuric acid.

Particularly preferred peroxyacids are those having the formula:

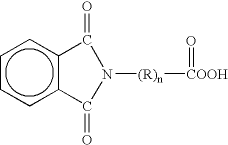

wherein R is C₁₋₄ alkyl and n is an integer of from 1 to 5.

A highly preferred preformed peroxyacid is PAP. As used herein, “PAP” refers to the preformed organic peroxyacid with the formula:

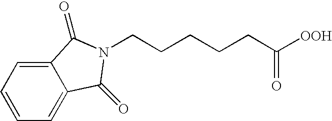

PAP is commercially available from Ausimont SpA™ under the tradename Eureko™

In a particularly preferred embodiment of the present invention the peroxyacid has mean average particle size of less than 100 microns, more preferably less than 80 microns, even more preferably less than 60 microns. Most preferably, when the peroxyacid is PAP, it has a mean average particle size of between about 20 and about 50 microns.

e) Optional Adjunct Materials

In addition, the bleaching compositions of the present invention may further comprise any ingredient listed hereinbefore under the section ‘Cleaning Adjunct Materials’ of the cleaning compositions according to the present invention, provided that there is no incompatibility between the equilibrium peracid and the selected ingredient. In particular, enzymes and other ingredients sensitive to oxidizing agents typically should not be formulated in the bleaching compositions according to the present invention, unless a suitable encapsulation method is used to protect them, in order to avoid storage stability problems. Also, surfactant and solvents should preferably be present at low levels (or absent) especially when the bleaching compositions comprise a suspended peracid, to prevent its solubilization.

The suspended peracid is preferably in the form of solid particles suspended in the bleaching composition. Therefore, the bleaching composition preferably further comprises a suspending agent described herein for the peracid.

The bleaching compositions of the present invention also preferably comprise an adjunct material selected from the groups of polymeric stabilization systems, chelating agents, radical scavengers, and alkoxylated benzoic acids, to help the physical and chemical stabilization of the peroxyacid(s). All of these ingredients have been described in the corresponding paragraphs hereinbefore.

Optional Foaming System

The laundry products of the present invention may further comprise a foaming system, such as those known in the art for providing foamed cleaning compositions. The foaming system may utilize the available hydrogen peroxide present in the bleaching composition by adding a catalyst to the cleaning composition. Alternatively, the foaming system may be formed by adding an acid to the bleaching composition (or utilizing the acid already present) and a base to the cleaning composition whereupon when the two compositions are mixed at the point of use, foaming reactions occur.

A) Hydrogen-peroxide based systems

In these embodiments the cleaning compositions may include an ‘effervescent agent’ which is preferably selected from a peroxide reducing enzyme, such as peroxidase, laccase, dioxygenase and/or catalase enzyme, preferably catalase enzyme. The efferevescent agent is preferably included in the cleaning composition at a level of from about 0.001% to about 10%, more preferably, from about 0.01% to about 5%, most preferably from about 0.1% to about 0.3% by weight of the cleaning composition. Catalase enzymes are commercially available, for instance, from Biozyme Laboratories under the trade name CAT-1 A; from Genencor International under the trade name OXY-GONE 400; and from Novo Nordisk.

B) Acid-Base systems

In order to provide foaming due to an acid-base reaction, the bleaching compositions herein may include a suitable acid agent, while the cleaning compositions herein include a base agent. When combined upon dispensing, foaming of the composition occurs due to the reaction between the acid and base components.

Suitable acids for use in the bleaching compositions herein result in a pH of the bleaching compositions of about 7 or less, preferably from about 0 to about 6, more preferably from about 2 to about 5. Preferably, the acid is included at a level of from about 1% to about 20%, more preferably from about 3% to about 10% by weight of the bleaching compositions.

Nonlimiting examples of suitable acids for use in the present invention include inorganic acids, organic acids and mixtures thereof. Preferably, the inorganic acids are selected from the group consisting of sulfuric acid, hydrochloric acid, phosphoric acid, nitric acid and mixtures thereof. Preferably, the organic acids are selected from the group consisting of formic acid, acetic acid, C₁₂-C₁₈ fatty acids, malic acid, maleic acid, malonic acid, succinic acid, tartaric acid, lactic acid, glutaric acid, fumaric acid, benzoic acid, phthalic acid, citric acid and mixtures thereof. Organic acids are preferred, most preferred are citric acid and/or succinic acid. Alternatively, the acid(s) may be the same parent carboxylic acid(s) which is(are) in equilibrium with the percarboxylic acid(s) comprised in the bleaching compositions according to the present invention.

The base that may be included in the cleaning compositions herein are preferably present at a level of from about 1% to about 10%, more preferably from about 2% to about 5% by weight of the cleaning composition.

Suitable bases for use in the cleaning compositions herein include, but are not limited to, carbonates, bicarbonates, sesquicarbonates and mixtures thereof. The most preferred bases are selected from the group consisting of sodium bicarbonate, monoethanolammonium bicarbonate and mixtures thereof.

In addition, foaming systems based on both types of foaming interactions may be included in the laundry products.

Methods of Laundry

The invention herein also encompasses a method for laundering fabrics wherein the fabrics are placed in the drum of a washing machine along with the laundry product of the present invention or are alternatively hand-washed in conjunction with the laundry product of the present invention. In addition, the invention herein also encompasses a laundering pretreatment process for fabrics which have been soiled or stained comprising directly contacting said stains and/or soils with a highly concentrated form of the laundry composition set forth above prior to washing such fabrics using conventional aqueous washing solutions. Preferably, the laundry composition remains in contact with the soil/stain for a period of from about 30 seconds to 24 hours prior to washing the pretreated soiled/stained substrate in conventional manner. More preferably, pretreatment times will range from about 1 to 180 minutes.

### EXAMPLES

### Examples 1A and 1B

Heavy duty aqueous liquid detergent compositions in accordance with the present invention are prepared in dual-compartment containers as follows (the dual compartment container is designed to deliver preferably a 1:1 weight ratio of the first compartment product vs the second compartment product).

| | 1A | 1B |
|---|---|---|
| | % by weight of | % by weight of |
| | composition in | composition in |
| | compartment | compartment |
| First Compartment | | |
| (cleaning composition) | | |
| C12-15 Alkyl alcohol 5 | 20 | 20 |
| ethoxylated | | |
| LAS | 10 | 10 |
| Propylene glycol | 5 | 5 |
| Cumene sulfonic acid | 5 | 5 |
| Monoethanolamine | to pH 8.5 | to pH 8.5 |
| Boosters, enzymes, perfume | 5 | 5 |
| Water | Balance | Balance |
| Second Compartment | | |
| (bleaching composition) | | |
| Hydrogen Peroxide | 6.0 | 12.0 |
| Acetic Acid | 1.6 | — |
| Monomethyl Glutaric Acid | — | As determined by |
| | | equilibrium |
| Peracetic Acid | 1.0 | — |
| Monomethyl Perglutaric Acid | — | 4.0 |
| Chelant (e.g. HEDP) | 0.1 | 0.1 |
| Mineral acid (e.g. sulphuric) | To pH 2 | To pH 1 |
| Water | Balance | Balance |

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A stable aqueous laundry product provided in a first and second part comprising:
a) a first part comprising a liquid cleaning composition, said cleaning composition having a pH of from about 4 to about 10 and comprising a detersive surfactant;
b) a second part comprising a bleaching composition having a pH of from about 0.5 to about 6, wherein said bleaching composition comprises an equilibrium peracid solution, and wherein the equilibrium peracid solution comprises:
i) a source of hydrogen peroxide;
ii) from about 20% to about 98% water;
iii) a water soluble carboxylic acid;
iv) a corresponding percarboxylic acid;
wherein the first and second parts are contained within a package wherein the first part is physically separated from the second part.

2. A laundry product according to claim 1 wherein the cleaning composition comprises from about 5% to about 70%, by weight of the cleaning composition, of the detersive surfactant system.

3. A laundry product according to claim 1 wherein the bleaching composition comprises from about 0.1% to about 100%, by weight of the bleaching composition, of the equilibrium peracid solution.

4. A laundry product according to claim 2 wherein the equilibrium peracid solution comprises from about 0.001% to about 15%, by weight of the equilibrium peracid solution, of the source of hydrogen peroxide.

5. A laundry product according to claim 4 wherein the equilibrium peracid solution comprises a weight ratio of the carboxylic acid to the corresponding percarboxylic acid of from about 100:1 to about 0.5:1.

6. A laundry product according to claim 5 wherein the.equilibrium peracid solution comprises from about 0.01% to about 50%, by weight of the equilibrium peracid solution, of the water-soluble percarboxylic acid.

7. A laundry product according to claim 6 wherein the bleaching composition further comprises from about 0.1% to about 25% of a suspended peracid.

8. A laundry product according to claim 5 wherein the hydrogen peroxide source is hydrogen peroxide and the carboxylic acid is succinic acid, glutaric acid, malic acid, maleic acid, adipic acid or monoalkyl esters thereof or mixture thereof

9. A laundry product according to claim 1 wherein the package includes a press-tap dispenser for the cleaning composition and the bleaching composition.

10. A laundry product according to claim 9 wherein the dispenser is capable of dispensing a first part to second part composition ratio of from about 40:60 to about 60:40.

11. A laundry product according to claim 1 wherein the product further comprises an effervescing system.

12. A laundry product according to claim 11 wherein the cleaning composition further comprises a hydrogen peroxide catalyst.

13. A laundry product according to claim 1 wherein the cleaning composition further comprises an enzyme.

14. A laundry product according to claim 1 wherein the cleaning system further comprises a hydrophobic bleach activator selected from NOBS, DOBS, LOBS, or mixtures thereof.

15. A laundry product according to claim 1 wherein the package is a dual-compartment container, having a first and second compartment.

16. A laundry product according to claim 15 wherein the cleaning composition is contained within the first compartment and the bleaching composition is contained within the second compartment.

17. A laundry product according to claim 16 wherein the cleaning composition and the bleaching composition are dispensed simultaneously.

18. A stable aqueous laundry product provided in a first and second part comprising:
a) a first part comprising a liquid cleaning composition, said cleaning composition having a pH of from about 4 to about 10 and comprising from about 5% to about 70%, by weight of the cleaning composition, of a detersive surfactant;
b) a second part comprising a bleaching composition, said bleaching composition having a pH of from about 0.5 to about 6, wherein said bleaching composition comprises an equilibrium peracid solution, and wherein the equilibrium peracid solution comprises;
i) a source of hydrogen peroxide;
ii) from about 20% to about 98% water;
iii) a dicarboxylic acid;
iv) a corresponding percarboxylic acid;
wherein the first and second parts are contained within a package wherein the first part is physically separated from the second part.

19. A laundry product according to claim 18 wherein the package is a dual-compartment container wherein the first part is contained within a first compartment and the second part is contained within a second compartment.

20. A method of laundering fabrics in a washing machine, said method comprising the steps of;
a) dispensing the cleaning composition and the bleaching composition from the laundry product of claim 1 into a washing machine;
b) at least partially filling the washing machine with water;
c) introducing dirty or soiled fabric items into the washing machine; and
d) running a standard wash cycle.
